(19) United States
(12) Patent Application Publication
(10) Pub. No.: US 2006/0145050 A1
(43) Pub. Date: Jul. 6, 2006

(54) Multi-block mold and system

(76) Inventors: Raymond R. Price, Rochester, MN (US); Brian A. Price, Rochester, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/321,405

(22) Filed: Dec. 29, 2005

Related U.S. Application Data
(60) Provisional application No. 60/640,384, filed on Dec. 30, 2004.

(51) Int. Cl. B41B 11/54

(52) U.S. Cl. 249/160

(57) ABSTRACT

A mold box for forming differently sized retaining wall blocks includes first and second end walls and first and second sidewalls, which define an opening therebetween. A first divider plate is provided to the opening and located relative to the first and second end walls to divide the opening into a first section and a second section. The width of the first section is greater than the width of the second section. Additional divider plates may be provided to the opening to define additional sections wherein slugs for wall blocks formed by each section will have different widths.

### REFERENCE TO RELATED APPLICATIONS

The present application claims priority to U.S. Provisional Patent Application Ser. No. 60/640,384, filed Dec. 30, 2004, the disclosure of which is incorporated herein by reference in its entirety.

### FIELD OF THE INVENTION

This invention relates generally to concrete wall blocks and their manufacture. More particularly, the present invention relates to a mold for simultaneously manufacturing wall blocks of different sizes with a single mold box.

### BACKGROUND OF THE INVENTION

Concrete blocks for free standing and retaining walls have been known and used for many years. They can be both functional and decorative, and range from small gardening applications to large-scale construction projects. Such walls are typically used to form horizontal surfaces or terraces by providing a generally vertical barrier behind which backfill may be deposited. Such walls reduce erosion and slumping and maximize land use.

Walls can be constructed from stackable concrete blocks. These types of blocks can generally be assembled quickly and economically due to the interlocking of adjacent courses of blocks. Typically, each block includes some type of interlocking system such as pins, lips or projections so that one course of blocks interlock with an adjacent course of blocks to create a stable structure. Blocks having these interconnections are generally of uniform size and shape, so that a wall created with such blocks must have a uniform appearance. Examples of such blocks are commonly owned co-pending U.S. patent application Ser. No. 10/033,460 and U.S. Pat. Nos. 6,250,850 and 6,682,269, which are hereby incorporated by reference in their entirety.

U.S. Pat. No. 5,827,015 describes the conventional dry cast manufacturing process used to manufacture concrete wall blocks. In such process, a mold box is used to form a slug that is subsequently split into two wall blocks. It is also known to provide mold boxes which can simultaneously form multiple slugs of identical size and shape. Presently, however, users desire to create walls that have a non-uniform shape by using blocks having more than one size or shape. The process of manufacturing multiple block sizes and shapes presents an increased cost due to the need to use multiple different mold boxes corresponding to each size and shape of block to be manufactured.

### SUMMARY OF THE INVENTION

The present invention addresses certain drawbacks present in the prior art by providing a mold and process for simultaneously manufacturing wall blocks of different sizes with a single mold box. The mold box for forming differently sized retaining wall blocks includes first and second end walls and first and second sidewalls, which define an opening therebetween. A first divider plate is provided to the opening and located relative to the first and second end walls to divide the opening into a first section and a second section. The width of the first section is greater than the width of the second section. Additional divider plates may be provided to the opening to define additional sections wherein slugs for wall blocks formed by each section will have different widths.

### DESCRIPTION OF THE DRAWINGS

FIG. 1 is a top view of a mold box according to an embodiment of the present invention.

FIG. 2 is a perspective view of a mold box according to an embodiment of the present invention.

FIG. 3 is a bottom view of a set of stripper shoes according to an embodiment of the present invention.

FIG. 4A is a bottom view and FIGS. 4B and 4C are cross-sectional views of a slug according to an embodiment of the present invention.

FIG. 5A is a bottom view and FIGS. 5B and 5C are cross-sectional views of a slug according to an embodiment of the present invention.

FIG. 6A is a bottom view and FIGS. 6B and 6C are cross-sectional views of a slug according to an embodiment of the present invention.

FIG. 7 is a perspective view of a portion of a wall system according to an embodiment of the present invention.

FIG. 8 is a perspective view of a portion of a wall system according to an embodiment of the present invention.

FIG. 9 is a side view of a column of blocks according to an embodiment of the present invention.

FIG. 10A is a top view of a mold box according to an embodiment of the present invention.

FIG. 10B is a perspective view of a divider plate and divider plate liner according to an embodiment of the present invention.

### DETAILED DESCRIPTION

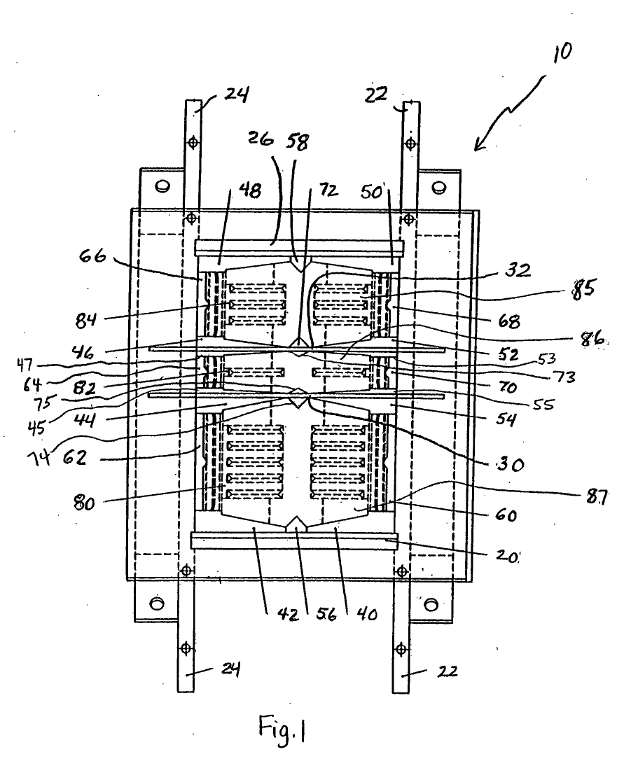

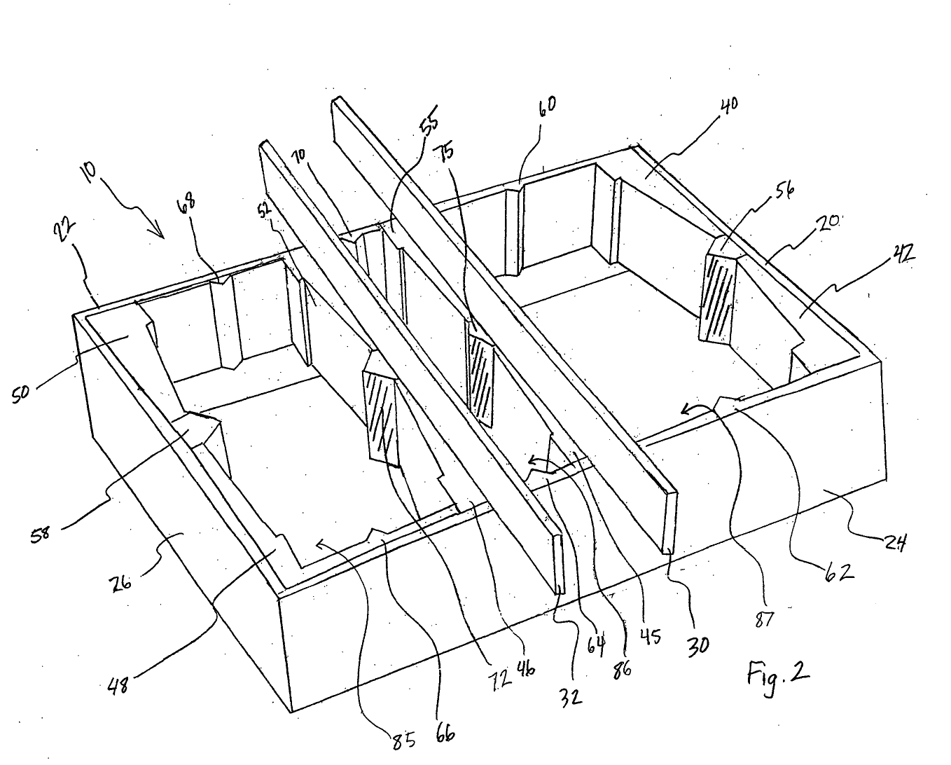

Referring to FIGS. 1 and 2, there can be seen a multi-block mold box 10 according to an embodiment of the present invention. Mold box 10 generally includes opposing first 20 and second 26 end walls and opposing first 22 and second 24 side walls. Divider plates 30 and 32 span the side walls 22 and 24 of the mold box 10, and may be adjustably positionable relative thereto. Divider plates 30, 32 are generally parallel to each other and to the end walls 20, 26 of the mold box 10. Alternatively, divider plates 30, 32 may be angled. Divider plates 30, 32 are located so that they define first 85, second 86, and third 87 mold cavities of differing sizes. Mold cavities 85, 86, 87 therefore form slugs with identical heights and depths, but differing widths.

In a preferred embodiment, the sum of the widths of first 85 and second 86 mold cavities equals the width of third mold cavity 87. This enables the blocks to be arranged and palletized as an assemblage or unit of blocks. It also ensures that enough differently sized blocks are being shipped to a particular job-site and simplifies cost estimates. One of skill in the art will appreciate that the number of divider plates may be varied to increase or decrease the number of mold units, and thus the number of differently sized blocks.

The mold box side walls 22, 24 and end walls 20, 26, as well as the divider plates 30, 32 may be modified by including liners that define the shape of the block being cast in each mold cavity 85, 86, 87. Mold cavity 87 may be modified by wall liners 40, 42, 56, 60 and 62, and divider plate liners 44, 54, and 74. Mold cavity 86 may be modified by wall liners 64 and 70, and divider plate liners 45, 47, 53, 55, 73, and 75. Mold cavity 85 may be modified by wall liners 66, 48, 50, 58, and 68, and by divider plate liners 46, 52, and 72. Liners 56, 74, 75, 73, 72, and 58 form part of the front facings of the blocks and as such are provided with a roughened exterior that imparts a textured surface to a portion of the block as it is being stripped from the mold. Preferably, the roughened exterior of these notch liners is striated.

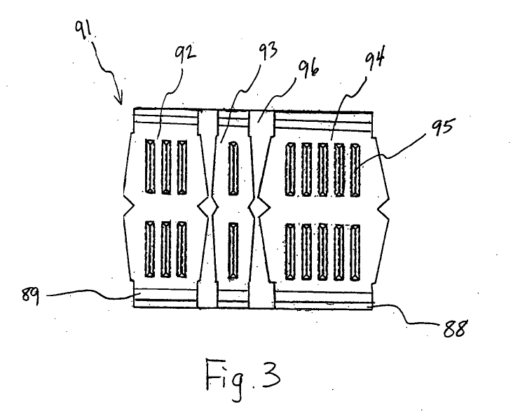

As with conventional mold boxes, the mold and divider plates of the present invention are configured to rest upon a pallet to form cavities. Masonry material is deposited into the cavities and later removed by stripper shoes 91 that contact the masonry material from above, compress it, and then push it free from the mold as the mold is lifted relative to the pallet. Stripper shoes 91 according to an embodiment of the present invention are shown in FIG. 3. There is a stripper shoe 92, 93, 94 for each mold cavity 85, 86, 87. Recesses 96 are provided between the stripper shoes 93, 93, 94 so that the shoes can compress the material contained within the mold cavities without interference by the wall liners, division plates, and division plate liners. Stripper shoes 92, 93, 94 also include a plurality of projections 95 that form grooves in the mold material. These projections are also shown with dashed lines 80, 82, and 84 in FIG. 1. In addition, stripper shoes 92, 93, 94 each include a pair of grooves 88 and a pair of protrusions 89 which form a pair of projections and a pair of gutters, respectively, in the mold material. It will be appreciated that the stripper shoes may be separate from one another or may be attached or ganged to each other such that the movement thereof is unimpeded by the divider plates and the castings may be removed simultaneously.

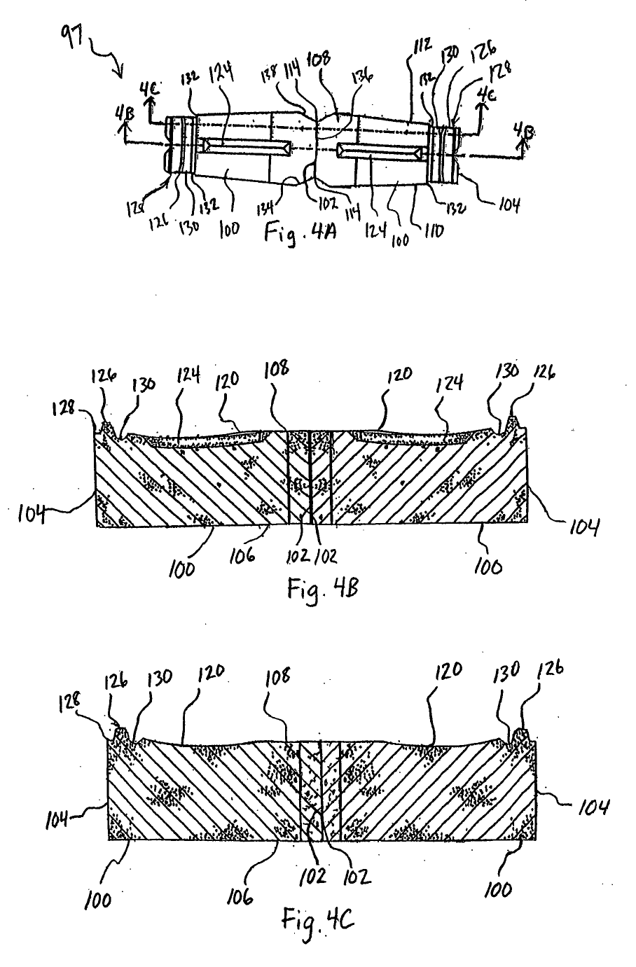

FIGS. 4A-4C depict a slug 97 formed in a mold cavity 86 according to an embodiment of the present invention. Slug 97 is a “twinned” unit, meaning that slug 97 comprises two identical, joined wall blocks 100. Slug 97 includes a pair of notches 114 which define the boundary where slug 97 can be split to form the two identical wall blocks 100. Each wall block 100 comprises a front surface 102 and opposing rear surface 104 that define a depth, a top surface 106 and opposing bottom surface 108 that define a height and first 110 and second 112 opposing side surfaces that define a width. Persons having skill in the art of concrete wall block manufacture will recognize that any number of textures can be imparted on the front surface 102 by the splitting of a slug into two blocks without departing from the spirit and scope of the present invention.

Front surface 102 comprises three facets 134, 136, 138. Middle facet 136 is generally parallel to rear surface 104 and end facets 134, 138 are set out at an angle thereto. Alternatively, front surface 102 may be given a curvilinear shape. Rear surface 104 has a width smaller than front surface 102, thus side surfaces 110, 112 running between front 102 and rear 104 surfaces are tapered. This shape allows the construction of straight, concave, convex, or serpentine walls without interrupting the relatively uniform appearance created by the front surfaces of the blocks forming the wall.

Bottom surface 108 includes a non-planar portion 120 that is preferably a relatively cylindrical indentation. Alternatively, non-planar portion 120 may be of any other shape, such as ovate or spherical. Non-planar portion 120 preferably does not intersect front surface 102, but rather flattens out before bottom surface 108 meets front surface 102. Because it is recessed from bottom surface 104, non-planar portion 120 forms a gap between bottom surface 108 of the block 100 and the flat top surface of a block upon which it is stacked. This gap allows for ease in picking up and setting down the block 100.

The bottom surface further includes a groove 124. Groove 124 is preferably “V” shaped. One of skill in the art will recognize that groove 124 may take other forms, such as circular, oblong, or arcuate without departing from the spirit and scope of the invention. Preferably, groove 124 is located in the non-planar portion 120 of bottom surface. Groove 124 results in a lighter block and also increases cost savings by using less concrete.

In addition, bottom surface includes a heel portion 128. Heel portion 128 includes a projection 126, a gutter 130, and rear surface 104. A pair of shoulders 132 defines the boundary of heel portion 128. Gutter 130 and projection 126 are spaced forward from the rear surface 104 by a predetermined distance. Positioning projection 126 away from rear surface 104 makes it less likely to be chipped and fractured while the block is being manipulated and positioned than if projection 126 is positioned at the edge of the block. Gutter 130 preferably has a generally “U” shaped cross-section and projection 126 preferably has a generally trapezoidal shape. One of skill in the art will recognize that both of these shapes may be varied.

The front surfaces of all of the blocks according to the present invention may be given a decorative appearance. Such decorative appearances include broken rock, stacked rocks, natural stone, brick, striated or roughened texture. Front surfaces may also be given various shapes, such as planar, angular, prismatic, or curvilinear. Persons of skill in the art of concrete block manufacturing using the dry-cast process will recognize that various decorative appearances can be imparted on the front surfaces of the blocks, and that the present invention is not limited to a specific decorative facial appearance unless specifically indicated in a given Claim.

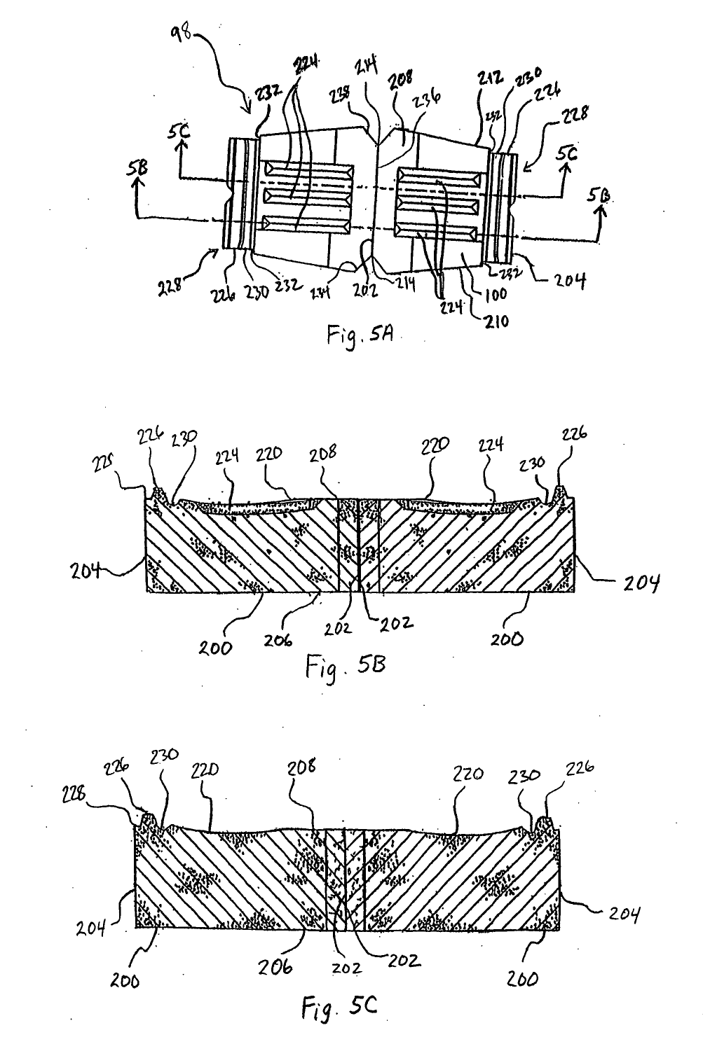

Referring to FIGS. 5A-5C, there can be seen another slug 98 formed in a mold cavity 85 according to an embodiment of the present invention. Slug 98 comprises two identical, joined wall blocks 200, with a separation boundary defined by a pair of notches 214. Each wall block 200 comprises a front surface 202 and opposing rear surface 204 defining a depth, a top surface 206 and opposing bottom surface 208 defining a height and first 210 and second 212 opposing side surfaces defining a width. Wall block 200 has identical height and depth as wall block 100, but a greater width.

Front surface 202 is comprised of three facets 234, 236, 238 and is of greater width than rear surface 204 such that side surfaces 210, 212 are tapered. Bottom surface 208 includes a non-planar portion 220 and a plurality of grooves 224. Grooves 224 are generally spaced equidistant from each other and extend across non-planar portion 220. Bottom surface 208 further includes a heel portion 228 comprising a gutter 230 and a projection 226 spaced at a predetermined distance from rear surface 204. The predetermined distance conforms to the predetermined distance at which gutter 130 and projection 126 are spaced from rear surface 104.

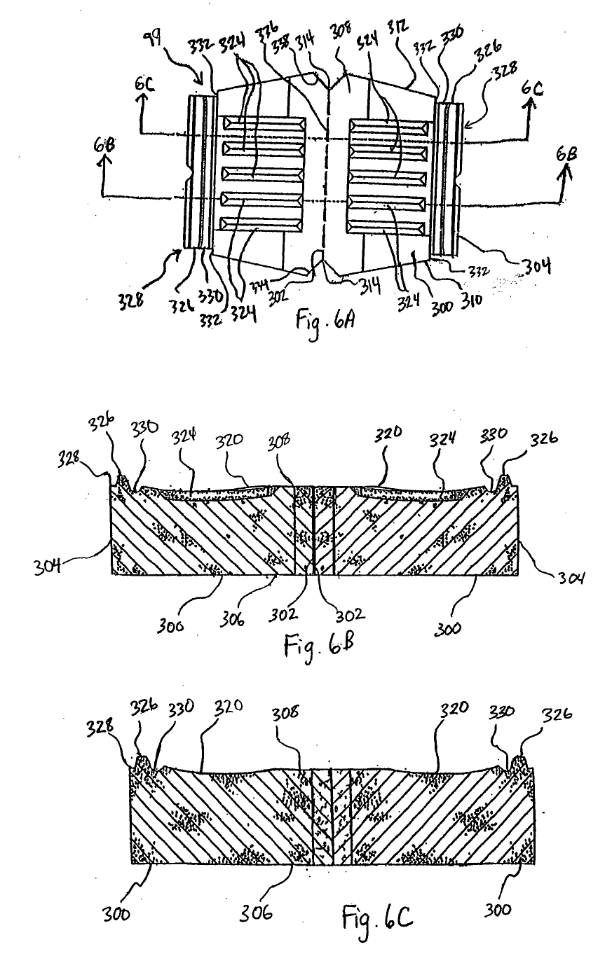

FIGS. 6A-6C depict another slug 99 formed in a mold cavity 87 according to an embodiment of the present invention. Slug 99 similarly comprises two identical, joined wall blocks 300, with a separation boundary defined by a pair of notches 314. Each wall block 300 comprises a front surface 302 and opposing rear surface 304 defining a depth, a top surface 306 and opposing bottom surface 308 defining a height and first 310 and second 312 opposing side surfaces defining a width. Wall block 300 has the same depth and height as wall block 100 and wall block 200, but has a greater width. Preferably, the width of wall block 300 is equal to the sum of the widths of wall block 100 and wall block 200.

Front surface 302 is comprised of three facets 334, 336, 338 and is of greater width than rear surface 304 such that side surfaces 310, 312 are tapered. Bottom surface 308 includes a non-planar portion 320 and a plurality of grooves 324. Grooves 324 are generally spaced equidistant from each other and extend across non-planar portion 320. Bottom surface 308 further includes a heel portion 328 comprising a gutter 330 and a projection 326 spaced at a predetermined distance from rear surface 304. The predetermined distance conforms to the predetermined distance at which gutters 130, 230 and projections 126, 226 are spaced from rear surfaces 104, 204.

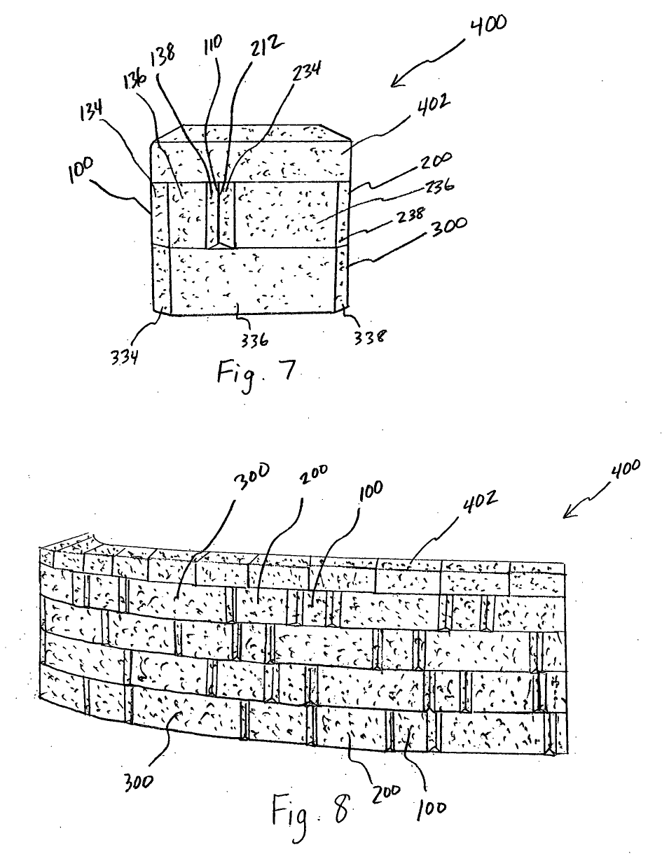

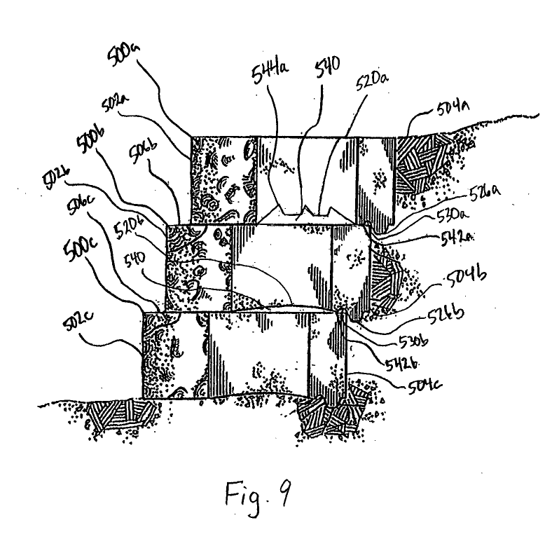

FIGS. 7 and 8 depict a portion of a wall system 400 according to an embodiment of the present invention. Wall portion 400 comprises large blocks 300 and smaller blocks 100, 200. As can be seen, sizing the larger block 300 to have a width the sum of the widths of the two smaller blocks 100, 200 allows for a wall with a finished appearance to be easily created. Adjacent blocks 100, 200 along a single course contact one another along the edges where facets 138, 234 meet side surfaces 110, 212. This gives the wall a finished appearance because no gaps are visible between blocks. Because the mold box forms differently sized blocks, a wide variety of differently configured retaining walls can be formed. Wall can also be formed in various shapes, for example linear or serpentine, or enclosures.

Retaining wall systems may also be provided with cap blocks 402 to provide a finished appearance to the wall. Cap blocks 402 may come in any configuration including flat and crowned. Cap blocks 402 may be manufactured or may be blocks of natural stone. Cap blocks 402 may have a flat bottom surface and simply rest on top of blocks 100, 200, 300. Adhesive can be used to secure the cap blocks 402 to the top of the wall.

Referring now to FIG. 9, the way that additional courses are added on top of each other is illustrated. Non-planar portions 520a, 520b form gaps 540 between adjacent blocks 500a, 500b, 500c which aids in handling and manipulation of the blocks. Non-planar portion may optionally be provided with additional grooves 544a across the bottom surface of the blocks to further aid in handling of the blocks. The rear portion of the blocks is supported only by an edge 542a, 542b formed by the intersection of non-planar portion 520a, 520b and gutter 530a, 530b. This reduces the effects of extraneous material such as rocks, sand, or bits of concrete that may be present on the top surface 506b, 506c of a lower course of blocks. The projection 526a, 526b of each upper block hangs below the top surface 506b, 506b of each lower block adjacent rear surface 504b, 504c. This creates an offset between the front surfaces 502a, 502b, 502c of each course of blocks.

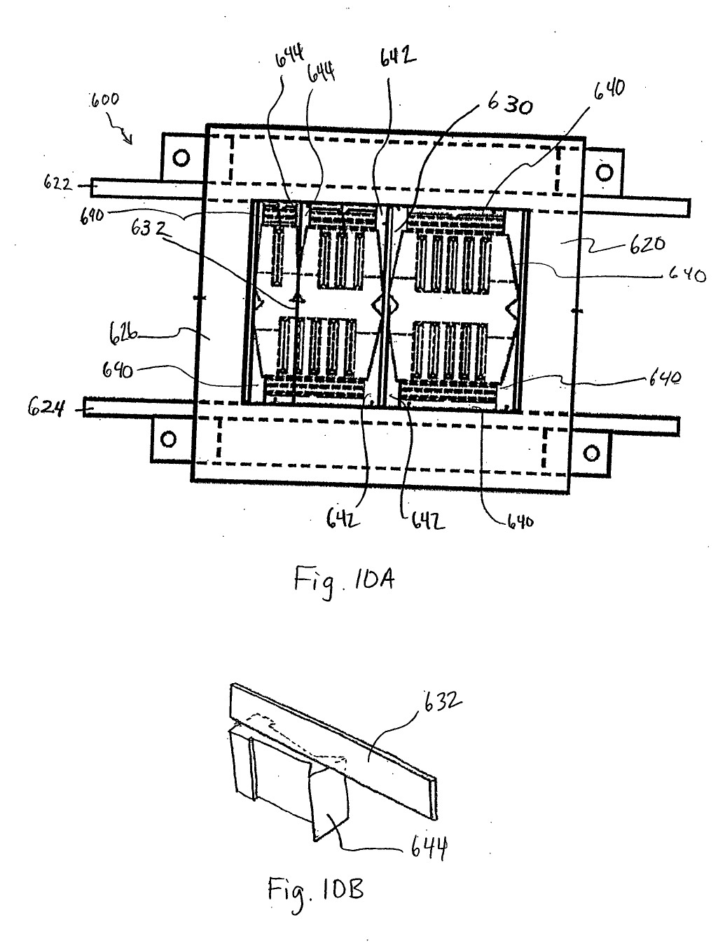

An alternative embodiment of a mold box and divider plates is depicted in FIGS. 10A and 10B. In this embodiment, a mold box 600 also comprising end walls 620, 626 and side walls 622, 624 is provided with divider plates 630, 632, wall liners 640, and divider plate liners 642, 644. Divider plate 630 and end liners 642 are substantially the same as those used in the embodiment depicted in FIG. 1. However, divider plate end liner 644 extends only partially between the side walls 622, 624 rather than completely spanning the distance between them as divider plate end liners 642 do. This enables the mold 600 to form an asymmetric unit, which can be split into an odd number of blocks. Alternatively, partial divider plate liner 644 may be removed so that the mold is able to produce two identical slugs.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the Claims.

What is claimed is:

1. A mold box for forming differently sized retaining wall blocks comprising:
first and second end walls and first and second sidewalls, which define an opening therebetween;
a first divider plate provided to the opening and located relative to the first and second end walls to divide the opening into a first section and a second section, wherein the first section has a first width defined between the divider plate and the first end wall and the second section has a second width defined between the divider plate and the second end wall, and wherein the first width is larger than the second width.

2. The mold box of claim 1, further comprising a liner provided to the first divider plate.

3. The mold box of claim 1, further comprising a second divider plate provided to the opening and located to divide the first section into a reduced first section having a reduced width defined between the first end wall and the second divider plate, and a third section having a third width defined between the first and second divider plates, wherein the reduced width of the reduced first section is greater than the third width.

4. The mold box of claim 3, wherein the sum of the reduced width of the reduced first section plus the third width are equal to the second width.

5. The mold box of claim 3, further comprising a liner provided to the second divider plate.

6. A mold for forming differently sized retaining wall blocks comprising:
a pair of spaced-apart sidewalls and a pair of spaced-apart endwalls defining an opening;
a plurality of dividers extending between the sidewalls so as to define a plurality of opening portions, each opening portion presenting a width dimension in a direction extending between the endwalls, the width dimension of each opening portion different from the width dimension of each other opening portion.

7. A method of simultaneously manufacturing retaining wall block slugs of varying widths by a dry-cast process, the method comprising the steps of:
providing a mold, the mold comprising a pair of sidewalls, a pair of end walls, an open top side and an open bottom side;
providing a pallet;
positioning a first divider plate within the mold to define a first section and a second section within the mold, wherein each of the first and second sections have unequal widths;
positioning the pallet with respect to the mold to temporarily close the open bottom side of the mold during a portion of the manufacturing process;
introducing a dry casting concrete mixture to the mold through the open top side;
vibrating the concrete mixture within the mold;
compacting the concrete mixture within the mold by pressing on the mix with a compression head to form a first and a second slug corresponding to the first and the second sections; and
releasing the formed first and second slugs from the mold through the open bottom side by moving the pallet relative to the mold.

8. The method of claim 7, further comprising the step of positioning a second divider plate within the mold to define a first section and a reduced width second section and a third section within the mold, wherein each of the first, reduced width second and third sections have unequal widths.

9. The method of claim 7, further comprising the step of imparting a textured surface to a portion of the slugs as they are stripped from the mold.

10. The method of claim 7, further comprising the step of splitting the slugs to form two separate wall blocks from each slug, wherein the splitting process imparts a textured surface on a front surface of each wall block.

11. The method of claim 7, wherein the step of compacting the concrete mixture within the mold by pressing on the mix with a compression head further forms a plurality of grooves in each slug

12. The method of claim 7, wherein the step of compacting the concrete mixture within the mold by pressing on the mix with a compression head further forms a plurality of non-planar portions in each slug.

13. The method of claim 7, wherein the step of compacting the concrete mixture within the mold by pressing on the mix with a compression head further forms a plurality of recessed portions in each slug so that wall blocks formed after a splitting process will form a gap portion between adjacent blocks.

14. The method of claim 7, wherein the step of compacting the concrete mixture within the mold by pressing on the mix with a compression head further forms an interlocking projection on each slug.

15. The method of claim 14, wherein the step of compacting the concrete mixture within the mold by pressing on the mix with a compression head further forms a gutter adjacent to the interlocking projection on each slug.

16. A method of simultaneously manufacturing retaining wall block slugs of varying widths by a dry-cast process, the method comprising the steps of:
providing a mold defining an opening;
interposing a first divider plate in the opening to define first and second portions of the opening, wherein the first and second portions of the opening have unequal area dimensions;
placing the mold on a pallet and introducing a dry casting concrete mixture to the mold; and
stripping formed first and second slugs from the mold corresponding to the first and second opening portions.

17. The method of claim 16, further comprising the step of interposing a second divider plate in the opening so as to define a plurality of opening portions within the mold, wherein each opening portion has an area dimension different from the area dimension of each other opening portion in the plurality.

18. The method of claim 16, further comprising the step of imparting a textured surface to a portion of the slugs as they are stripped from the mold.

19. The method of claim 16, further comprising the step of compacting the concrete mixture within the mold by pressing on the mix with a compression head.

20. The method of claim 19, further comprising the step of forming a plurality of non-planar portions in each slug so that wall blocks formed after a splitting process will form a gap portion between adjacent blocks.
